(19) United States
(12) Patent Application Publication
(10) Pub. No.: US 2023/0257023 A1
(43) Pub. Date: Aug. 17, 2023

(54) VEHICLE FRONT STRUCTURE

(71) Applicant: HONDA MOTOR CO., LTD., Tokyo (JP)

(72) Inventors: Yui OTANI, Tokyo (JP); Naoki NAKAMOTO, Tokyo (JP)

(21) Appl. No.: 18/165,976

(22) Filed: Feb. 8, 2023

(30) Foreign Application Priority Data
Feb. 15, 2022 (JP) 2022-020977

(51) Int. Cl. B62D 25/08

(52) U.S. Cl. CPC B62D 25/08

(57) ABSTRACT

A vehicle front structure has a rectangular frame-shaped bulkhead provided in a front part of a vehicle to support a heat exchanger. The bulkhead includes vehicle fixation portions for fixing the bulkhead to a vehicle body and step portions provided below the vehicle fixation portions. A width dimension in a vehicle front-rear direction of a part of the bulkhead above each step portion is the same as a width dimension in the vehicle front-rear direction of a part of the bulkhead below the step portion.

### BACKGROUND OF THE INVENTION

### 1. Field of the Invention

The present invention relates to a vehicle front structure having step portions at lower portions of both side surfaces of a bulkhead made of resin.

### 2. Description of the Related Art

A bulkhead disposed in a front part of a vehicle to support a heat exchanger such as a radiator is connected to a pair of side members disposed at the left and right sides of the vehicle. As one example of this structure, in a vehicle described in Patent Literature 1, a bulkhead which is in the front of the vehicle and made of resin is connected to front side frames (side members). The lower portions of the side surfaces of the bulkhead are each provided with a step in the vehicle width direction.

### PRIOR ART DOCUMENT(S)

### Patent Literature(s)

Patent Literature 1: JP2018-096280A

In a case of the bulkhead made of resin in Patent Literature 1, in an event where a lower part of the vehicle front comes into contact with the ground surface when the vehicle is travelling across the border between a slope and a flat road, the bulkhead may receive a load attributed to the contact, depending on the structure of the vehicle. A structure in which a soft under cover is disposed under the bulkhead is an example of such a vehicle structure, and because the under cover is soft, a load is transmitted to the bulkhead substantially directly.

Because the step portions are provided at the lower portions of both of the side surfaces of the bulkhead made of resin, upon receipt of the load, lateral members of the bulkhead may crack or bend at the step portions. Cracking or bending of the lateral members of the bulkhead leads to a problem of no longer being able to support the heat exchanger.

### SUMMARY OF THE INVENTION

The present invention has been made in view of such circumstances and has an object to provide a vehicle front structure capable of maintaining the heat exchanger support structure of a bulkhead even when a lower part of the vehicle front comes into contact with the ground surface and in turn to improve traffic safety and convenience.

A vehicle front structure of the present invention to achieve the above object is a vehicle front structure having a rectangular frame-shaped bulkhead provided in a front part of a vehicle to support a heat exchanger, in which the bulkhead includes vehicle fixation portions for fixing the bulkhead to a vehicle body and step portions provided below the vehicle fixation portions, and a width dimension in a vehicle front-rear direction of a part of the bulkhead above each of the step portions is same as a width dimension in the vehicle front-rear direction of a part of the bulkhead below the step portion.

The present invention can provide a vehicle front structure capable of maintaining a heat exchanger support structure of a bulkhead even when a lower part of the vehicle front comes into contact with the ground surface, and in turn, the present invention can obtain a vehicle front structure that can improve traffic safety and convenience.

### BRIEF DESCRIPTION OF THE DRAWINGS

FIG. 1 is a perspective view showing the structure of the rear surface of a bulkhead disposed in a hood at a vehicle front.

FIG. 2 is a perspective view showing the configuration of a left column member of the bulkhead as seen in a perspective rear view, in the part surrounded by the two-dot dash line shown in FIG. 1.

FIG. 3 is a perspective view showing the configuration of the left column member of the bulkhead as seen in a perspective front view, in the part surrounded by the broken line shown in FIG. 1.

FIG. 4 is a side view showing the configuration of the left column member shown in FIG. 3 as seen in a side view.

### DETAILED DESCRIPTION OF THE EMBODIMENTS

### Configuration of an Embodiment

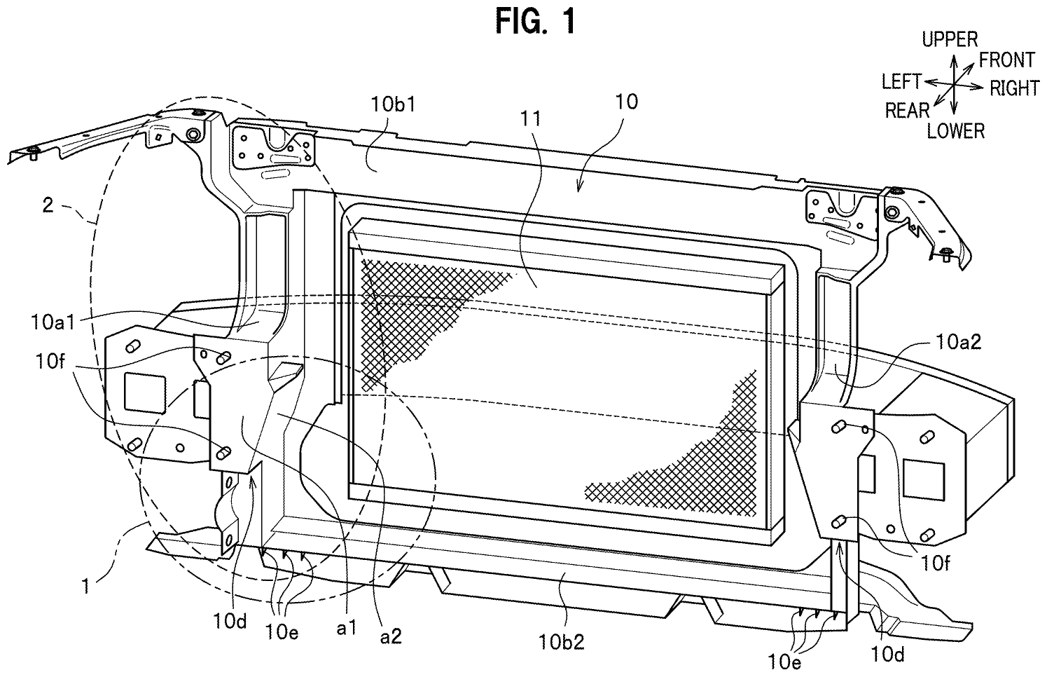

An embodiment of the present invention is described in detail with reference to FIGS. 1 to 4. In the description, the same elements are denoted by the same reference numeral to omit repetitive descriptions. Also, in the drawings, “front-rear,” “left-right,” and “upper-lower” denoted by the arrows represent the front-rear direction of the automobile (not shown), the width direction of the automobile, and vertical upper-lower direction, respectively.

FIG. 1 shows the configuration of a bulkhead 10 disposed in a hood at a vehicle front as seen from the rear of the vehicle. The bulkhead 10 is made of resin, is disposed in a front part of the vehicle, forms a rectangular frame shape in a rear view (or in a front view), and supports a heat exchanger 11, such as a radiator, inside the rectangular frame. The rectangular frame formed by the bulkhead 10 includes beam members 10b1, 10b2 being away from each other in the upper-lower direction and expending horizontally in the vehicle width direction (the lateral direction) and left and right column members 10a1, 10a2 connecting both ends of the upper and lower beam members 10b1, 10b2 in the upper-lower direction (the longitudinal direction).

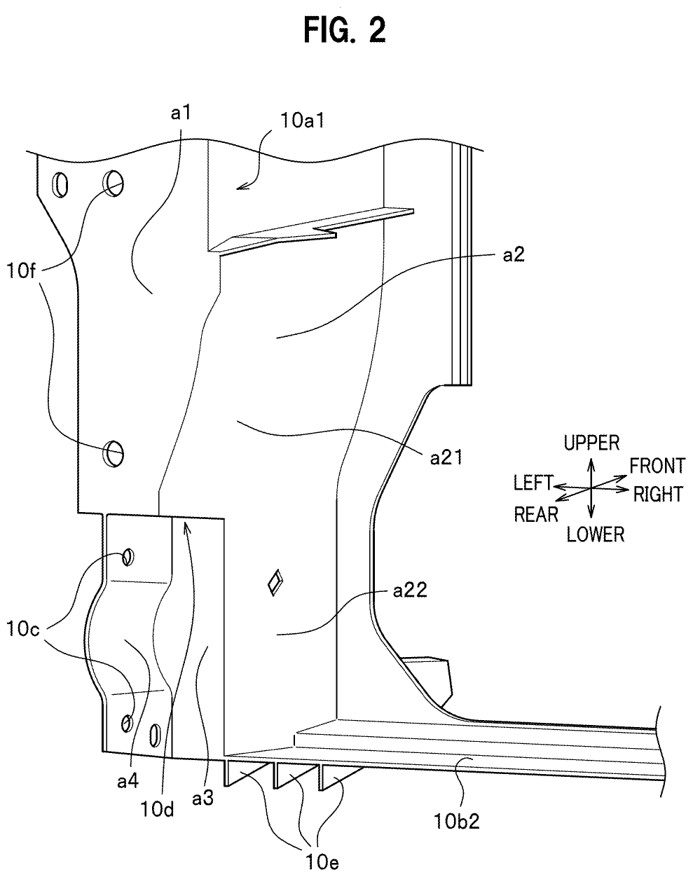

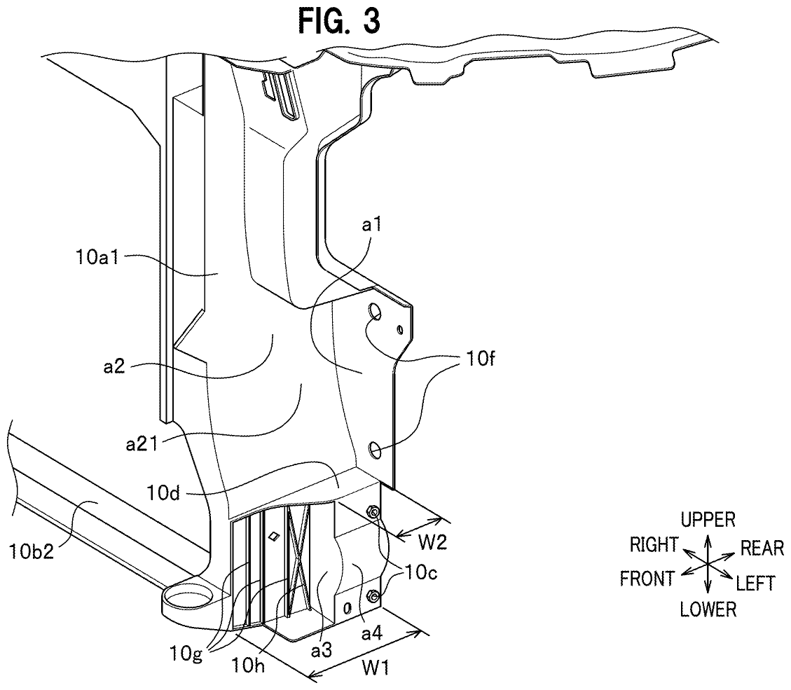

The bulkhead 10 is fixed to the vehicle body at the column members 10a1, 10a2 each by two vehicle fixation portions 10f away from each other in the upper-lower direction. The upper and lower vehicle fixation portions 10f are provided in a vehicle body fixation surface portion a1 (see FIG. 2 or 3) that extends from an upper-lower middle position of the each of the column members 10a1, 10a2 to a lower position for a predetermined length and faces in the vehicle front-rear direction in the column members 10a1, 10a2.

Further, the upper and lower vehicle fixation portions 10f are configured such that the vehicle body fixation surface portion a1 facing rearward is fixed to the vehicle body by screws, bolts, or the like inserted through through-holes formed in the vehicle body fixation surface portion a1. The vehicle body fixation surface portion a1 is continuous at a right angle with a column side surface portion a2 facing in the vehicle width direction (see FIGS. 2 and 3). The column side surface portion a2 extends between the upper and lower beam members 10b1, 10b2. The column side surface portion a2 and the vehicle body fixation surface portion a1 are shaped like the letter L in cross section.

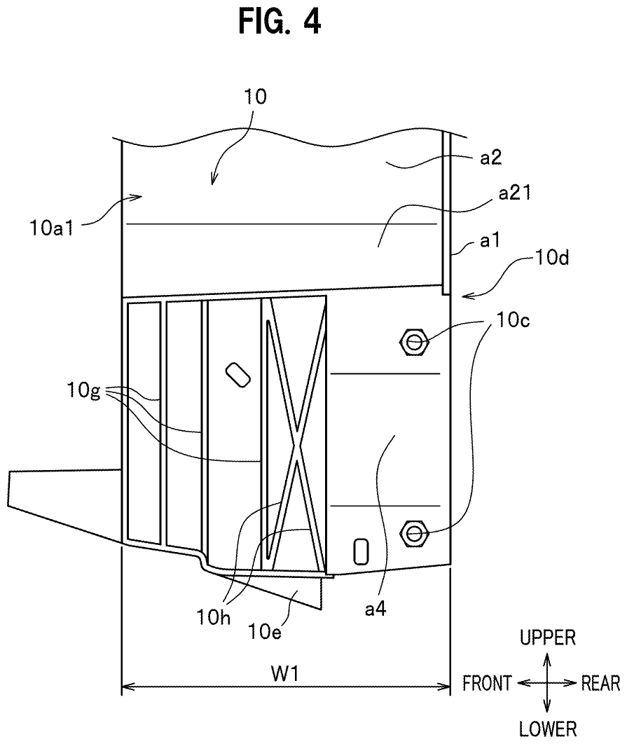

FIG. 2 shows the configuration of the left column member 10a1 of the bulkhead 10 as seen in a perspective rear view, in the part 1 surrounded by the two-dot dash line shown in FIG. 1. FIG. 3 shows the configuration of the left column member 10a1 of the bulkhead 10 as seen in a perspective front view, in the part 2 surrounded by the broken line shown in FIG. 1. FIG. 4 shows the configuration of the left column member 10a1 shown in FIG. 3, as seen in a side view.

As shown in FIG. 2, at the left column member 10a1, the column side surface portion a2 has a joint surface a21 which is at a vehicle inner side and joined to the vehicle body fixation surface portion a1 and a side surface portion a22 which is at a vehicle inner side and located lower than the joint surface a21, and the side surface portion a22 is shorter than the joint surface a21 in the vehicle front-rear direction. Joined at a right angle to the lower side surface portion a22 is a pump support surface portion a3 (see FIG. 3) facing in the front-rear direction. The pump support surface portion a3 is provided extending from a middle portion, in the front-rear direction, of the column member 10a1, extending over a lower portion thereof. Joined to the pump support surface portion a3 is a pump fixation surface portion a4 provided with water pump fixation portions 10c. The pump fixation surface portion a4 has its plate-shaped center portion curving and protruding outward in the vehicle width direction and is perpendicularly joined to and raised from the pump support surface portion a3 rearward.

There is a stair-like step portion 10d between the pump support surface portion a3 and the vehicle body fixation surface portion a1. The step portion 10d is provided at each of the left and right column members 10a1, 10a2 (FIG. 1) of the bulkhead 10, below the vehicle fixation portions 10f (or the vehicle body fixation surface portion a1). In the perspective side view shown in FIG. 3, the step portion 10d is located at the border between the joint surface a21 joined at a right angle to the vehicle body fixation surface portion a1 and the pump fixation surface portion a4 below the joint surface a21. Also, as shown in FIG. 1, when the bulkhead 10 has a lateral suspension structure in which the heat exchanger 11 is suspended and supported on a lateral axis, the step portion 10d is located lower than the lateral suspension portion. Thus, in an event where a lower part of the vehicle front comes into contact with the ground surface when the vehicle is travelling across the border between a slope and a flat road, a load attributed to the contact is absorbed by the step portions 10d, which makes it possible to prevent breakage of the lateral suspension portion for the heat exchanger 11 located higher than the step portions 10d.

As shown in FIG. 3, each column member 10a1 includes the step portion 10d. The step portion 10d has a horizontal plane substantially trapezoidal in plan view and extends in the front-rear direction and the vehicle width direction. A width dimension W2 of the step portion 10d in the front-rear direction as seen from the outer side of the vehicle is smaller than a width dimension W1 of the column member 10a1 in the front-rear direction. The step portion 10d is disposed closer to the rear side of the column member 10a1. As shown in FIG. 4, the width dimension W1 in the vehicle front-rear direction of a part of the column member 10a1 above the step portion 10d is the same as the width dimension W1 in the vehicle front-rear direction of a part of the column member 10a1 below the step portion 10d. In other words, the side surface of the bulkhead has the same width W1 in the vehicle front-rear direction above and below the step portion 10d.

Further, as shown in FIG. 2, the step portion 10d is provided in such a manner as to form a step in both of the vehicle front-rear direction and the vehicle width direction.

Specifically, due to the step portion 10d, the vehicle body fixation surface portion a1 and the pump support surface portion a3 are located at different positions in the front-rear direction. Also, due to the step portion 10d, the column side surface portion a2 and the pump fixation surface portion a4 are located at different locations in the vehicle width direction.

As shown in FIG. 3, longitudinal ribs 10g are provided on a side surface of the column member 10a1, located lower than the step portion 10d and extending in the upper-lower direction.

Cross ribs 10h are provided rearward of the longitudinal ribs 10g. The cross ribs 10h are provided at a position closer to the step portion 10d than the longitudinal ribs 10g are in the vehicle front-rear direction. As shown in FIG. 4, the cross ribs 10h are configured such that two brace-shaped ribs 10h, 10h slanted in opposite directions intersect each other on the side surface of the column member 10a1. In other words, the column member 10a1 includes, on its side surface, the brace-shaped highly-rigid cross ribs 10h slanted in opposite directions and intersecting each other, the cross ribs 10h located lower than the step portion 10d and rearward of the longitudinal ribs 10g.

For example, in an event where a lower part of the vehicle front comes into contact with the ground surface when the vehicle is travelling across the border between a slope and a flat road, a load attributed to the contact with the ground surface is applied to the bulkhead 10 obliquely upward to the rear side. In this event, a larger load is transmitted to the cross ribs 10h with high rigidity at the rear side via the longitudinal ribs 10g at the front side.

As shown in FIG. 1, the lower beam member 10b2 is bridged across the lower end portions of the left and right column members 10a1, 10a2 of the bulkhead 10. A plurality of (three) lower ribs 10e (see FIG. 2) are provided at each of the left and right sides of the lower surface of the lower beam member 10b2, protruding downward. As shown in FIG. 4, the lower ribs 10e are located below the longitudinal ribs 10g and the cross ribs 10h of the column member 10a1 and each form the shape of a right triangle whose hypotenuse slants downward from the vehicle front to the rear side. In other words, in a state where the vehicle is on a flat surface, the lower ribs 10e each have a shape such that the lower rib 10e gets closer and closer to the ground surface from its front end to its rear end.

Thus, in an event where a lower part of the vehicle front comes into contact with the ground surface when the vehicle is travelling across the border between a slope and a flat road, the front end sides of the lower ribs 10e do not come into contact, and the rear sides thereof come into contact first and receive a load. This load is transmitted to the cross ribs 10h with high rigidity located immediately above the rear sides of the lower ribs 10e.

### Advantageous Effects of the Embodiment

Next, the characteristic configuration of the vehicle front structure of the present embodiment described above and advantageous effects offered thereby are described.

(1) The vehicle front structure has the rectangular frame-shaped bulkhead 10 provided at the front part of the vehicle to support the heat exchanger 11. The bulkhead 10 includes the vehicle fixation portions 10f for fixing the bulkhead 10 to the vehicle body and the step portions 10d provided below the vehicle fixation portions 10f. The width dimension W1 in the vehicle front-rear direction of a part of the bulkhead 10 above each step portion 10d is the same as the width dimension W1 in the vehicle front-rear direction of a part of the bulkhead 10 below the step portion 10d.

According to this configuration in which the bulkhead 10 has the same width dimension W1 in the vehicle front-rear direction above and below the step portion 10d, in an event where a lower part of the vehicle front comes into contact with the ground surface when the vehicle is travelling across the border between a slope and a flat road, a load attributed to the contact is evenly transmitted upward and thus can be evenly received by the column members 10a1, 10a2. The load is therefore distributed over the entire bulkhead 10, which makes it less likely for the bulkhead 10 to bend.

Because the bulkhead 10 is provided with the step portions 10d which absorb a load transmitted from below, the load is less likely to be transmitted to parts higher than the step portions 10d. Thus, when the load is strong, parts of the bulkhead 10 that are lower than the step portions 10d crack, and the cracking stops at the step portions 10d. Parts of the bulkhead 10 that are higher than the step portion 10d can thus be prevented from breaking. As a result, the vehicle fixation portions 10f and the lateral suspension support for the heat exchanger 11 that are higher than the step portion 10d can be kept intact. A vehicle having this vehicle front structure can improve traffic safety and helps traffic fluidity not to decrease.

(2) Aside surface of the bulkhead 10 facing in the front-rear direction is such that a part above the step portion 10d and a part below the step portion 10d are located at different positions in the front-rear direction with the step portion 10d in between, and a side surface of the bulkhead 10 facing in the vehicle width direction is such that a part above the step portion 10d and a part below the step portion 10d are located at different positions in the vehicle width direction with the step portion 10d in between.

According to this configuration in which the bulkhead 10 is provided with the step portions 10d each forming a step in the front-rear direction and a step in the left-right direction, a load transmitted from below is less likely to be transmitted to parts higher than the step portions 10d.

(3) The bulkhead 10 includes a rib (longitudinal ribs 10g) extending in the upper-lower direction and located lower than each of the step portions 10d.

According to this configuration, because the longitudinal ribs 10g have high strength against a load in the upper-lower direction, rigidity can be enhanced for parts lower than the step portion 10d.

(4) On a side surface of the bulkhead 10, the bulkhead 10 includes the brace-shaped cross ribs 10h slanted in opposite directions, intersecting each other, and located lower than the step portion 10d.

According to this configuration in which the bulkhead 10 includes the cross ribs 10h below each of the step portions 10d, rigidity can be enhanced for parts lower than the step portion 10d even more. A larger load is applied to a part under and near the step portion 10d, and this load is transmitted more greatly to the rear side. However, this transmitted load can be absorbed by the cross ribs 10h with high rigidity.

(5) The bulkhead 10 includes, below each set of the cross ribs 10h, the triangular lower ribs 10e whose hypotenuse slants downward from the vehicle front to the rear side.

According to this configuration, in an event where a lower part of the vehicle front comes into contact with the road surface when the vehicle is travelling across the border between a slope and a flat road, the front sides of the lower ribs 10e do not come into contact, and the rear sides of the lower ribs 10e come into contact first and receive the load. This load is transmitted to the cross ribs 10h with high rigidity located immediately above the rear sides of the lower ribs 10e. This can make it less likely for the bulkhead 10 to bend or break.

(6) The rib described in (3) is the longitudinal ribs 10g extending perpendicularly with the vehicle being on a horizontal plane, and the cross ribs 10h are provided rearward of the longitudinal ribs 10g.

According to this configuration, in an event where a lower part of the vehicle front comes into contact with the ground surface when the vehicle is travelling across the border between a slope and a flat road, a load attributed to the contact with the ground surface is applied to the bulkhead 10 obliquely upward to the rear side. Thus, a larger load is transmitted to the cross ribs 10h with high rigidity at the rear side via the longitudinal ribs 10g at the front side. In other words, the load can be transmitted more to the cross ribs 10h with high rigidity, which can make it less likely for the bulkhead 10 to bend or break.

Although the vehicle body structure according to the present embodiment has thus been described, the present invention is not limited to this and can be appropriately modified without departing from the gist of the present invention.

What is claimed is:

1. A vehicle front structure having a rectangular frame-shaped bulkhead provided in a front part of a vehicle to support a heat exchanger, wherein
the bulkhead includes
vehicle fixation portions for fixing the bulkhead to a vehicle body and
step portions provided below the vehicle fixation portions, and
a width dimension in a vehicle front-rear direction of a part of the bulkhead above each of the step portions is same as a width dimension in the vehicle front-rear direction of a part of the bulkhead below the step portion.

2. The vehicle front structure according to claim 1, wherein
a side surface of the bulkhead facing in the front-rear direction is such that a part above the step portion and a part below the step portion are located at different positions in the front-rear direction with the step portion in between, and
a side surface of the bulkhead facing in a vehicle width direction is such that a part above the step portion and a part below the step portion are located at different positions in the vehicle width direction with the step portion in between.

3. The vehicle front structure according to claim 1, wherein
the bulkhead includes a rib extending in an upper-lower direction and located lower than each of the step portions.

4. The vehicle front structure according to claim 3, wherein
on a side surface of the bulkhead, the bulkhead includes brace-shaped cross ribs slanted in opposite directions, intersecting each other, and located lower than the step portion.

5. The vehicle front structure according to claim 4, wherein
the bulkhead includes, below each set of the cross ribs, a triangular lower rib whose hypotenuse slants downward from the front of the vehicle to a rear side.

6. The vehicle front structure according to claim 4, wherein
the rib is a longitudinal rib extending perpendicularly with the vehicle being on a horizontal plane, and
the cross ribs are provided rearward of the longitudinal rib.
